(19) United States
(12) Patent Application Publication
(10) Pub. No.: US 2024/0419251 A1
(43) Pub. Date: Dec. 19, 2024

(54) TACTILE PRESENTATION DEVICE AND CONTROL METHOD

(71) Applicant: Nippon Telegraph and Telephone Corporation, Tokyo (JP)

(72) Inventor: Toshiki Wada, Tokyo (JP)

(21) Appl. No.: 18/701,463

(22) PCT Filed: Dec. 9, 2021
(86) PCT No.: PCT/JP2021/045307

§ 371 Date: Apr. 15, 2024

(51) Int. Cl. G06F 3/01; G06F 3/041; G06F 3/04812

(52) U.S. Cl. CPC G06F 3/016; G06F 3/0414; G06F 3/04812; G06F 2203/04105

(57) ABSTRACT

An embodiment is a tactile sense presentation device including a storage device configured to store image data indicating an object, a screen display circuit configured to display the object on a screen on a basis of the image data, a tactile sense presentation circuit configured to present a tactile sense corresponding to hardness of the object to a person, a pressing force detection circuit configured to detect a pressing force generated when a person touches the tactile sense presentation circuit, and a control circuit configured to change the tactile sense to be presented by the tactile sense presentation circuit on a basis of the hardness of the object and the pressing force detected by the pressing force detection circuit.

### CROSS-REFERENCE TO RELATED APPLICATIONS

This application is a national phase entry of PCT Application No. PCT/JP2021/045307, filed on Dec. 9, 2021, which application is hereby incorporated herein by reference.

### TECHNICAL FIELD

The present invention relates to a tactile sense presentation technology for presenting a virtual tactile sense by driving a tactile sense presentation device.

### BACKGROUND

In recent years, virtual reality (VR) has been researched to make a person experience a virtual world generated by a computer as if the virtual world were real. Further, a virtual reality reproduction device capable of realistically reproducing visual sense, auditory sense, and tactile sense by using images and sounds is also being developed. For example, a head mounted display (HMD) is known as a device capable of reproducing stereoscopic images and sounds.

Meanwhile, a tactile sense presentation device attracts attention as a device capable of reproducing a tactile sense of a person. The tactile sense presentation device is configured to present a cutaneous sensory feedback, that is, a virtual tactile sense, to a person by a tactile sense such as force, vibration, or temperature, by driving a tactile sense presentation device such as a vibration device or a Peltier device.

Conventionally, a tactile sense presentation device has been considered to be used as a tactile medium for remote communication. Non Patent Literature 1 describes a remote communication system in which tactile sense presentation devices including a communication device having a screen, a contact sensor, and a vibrator are connected to each other via the Internet. In this remote communication system, when a person touches one screen, vibration of the touch is detected by one communication device via the contact sensor. This vibration is notified to the other communication device via the Internet, and the vibrator is driven. As a result, the other screen vibrates and is transmitted to the other person as a tactile sense. In addition, when a person touches an object of a different material on the screen, vibration corresponding to hardness of the material is output from the vibrator, and a different tactile sense is presented.

### CITATION LIST

### Non Patent Literature

Non Patent Literature 1: Hirohiko Hayakawa et al., “Koujikkan wo tomonau enkaku communication no tame no souhoukougata sicho shokkaku media “koushu shokkaku denwa” no teian (in Japanese) (Proposal of interactive viewing tactile media “public tactile communication” for remote communication with high realistic feeling)”, TVRSJ Vol. 25 No. 4 pp. 412-421, 2020

### SUMMARY

### Technical Problem

According to the tactile sense presentation device described in the existing technology of Non Patent Literature 1, different tactile senses corresponding to the hardness of the material of the object can be presented. Here, an actual tactile sense changes depending on strength of a force generated when a person touches an object, and the person feels a strong tactile sense when the person strongly touches the object and feels a weak tactile sense when the person weakly touches the object. However, in the above-described tactile sense presentation device, only absolute constant hardness is presented for each material, and the presented tactile sense does not change even if forces generated when the person touches the object are different. Therefore, there is a problem that a virtual tactile sense with high reality cannot be presented.

The present invention is intended to solve such a problem, and an object of the present invention is to provide a tactile sense presentation device capable of presenting a tactile sense corresponding to a force generated when touching an object.

### Solution to Problem

To achieve such an object, a tactile sense presentation device according to embodiments of the present invention includes: a storage device configured to store image data indicating an object; a screen display circuit configured to display the object on a screen on a basis of the image data; a tactile sense presentation circuit configured to present a tactile sense corresponding to hardness of the object to a person; a pressing force detection circuit configured to detect a pressing force generated when a person touches the tactile sense presentation circuit; and a control circuit configured to change the tactile sense to be presented by the tactile sense presentation circuit on a basis of the hardness of the object and the pressing force detected by the pressing force detection circuit.

Furthermore, a control method according to embodiments of the present invention is a control method used in a tactile sense presentation device including a storage device, a screen display circuit, a tactile sense presentation circuit, a pressing force detection circuit, and a control circuit, the control method including: a storage step configured to store, by the storage device, image data indicating an object; a screen display step configured to display, by the screen display circuit, the object on a screen on a basis of the image data; a tactile sense presentation step configured to present, by the tactile sense presentation circuit, a tactile sense corresponding to hardness of the object to a person; a pressing force detection step configured to detect, by the pressing force detection circuit, a pressing force generated when a person touches the tactile sense presentation circuit; and a control step configured to change, by the control circuit, the tactile sense to be presented by the tactile sense presentation circuit on a basis of the hardness of the object and the pressing force detected by the pressing force detection circuit.

### Advantageous Effects of Invention

According to embodiments of the present invention, it is possible to provide a tactile sense presentation device that presents a tactile sense corresponding to a force generated when touching an object.

### BRIEF DESCRIPTION OF THE DRAWINGS

FIG. 1 is a block diagram illustrating a configuration of a tactile sense presentation device according to the present embodiment.

FIG. 2 is an explanatory diagram illustrating an operation of the tactile sense presentation device.

FIG. 3 is a sequence diagram of a method for controlling a tactile sense presentation device.

FIG. 4 is an explanatory diagram illustrating a displacement amount of a contact portion.

FIG. 5 is an explanatory diagram illustrating an adjusted displacement amount of the contact portion.

### DETAILED DESCRIPTION OF ILLUSTRATIVE EMBODIMENTS

Next, an embodiment of the present invention will be described with reference to the drawings. The present invention is not limited to the embodiment described below.

### Present Embodiment

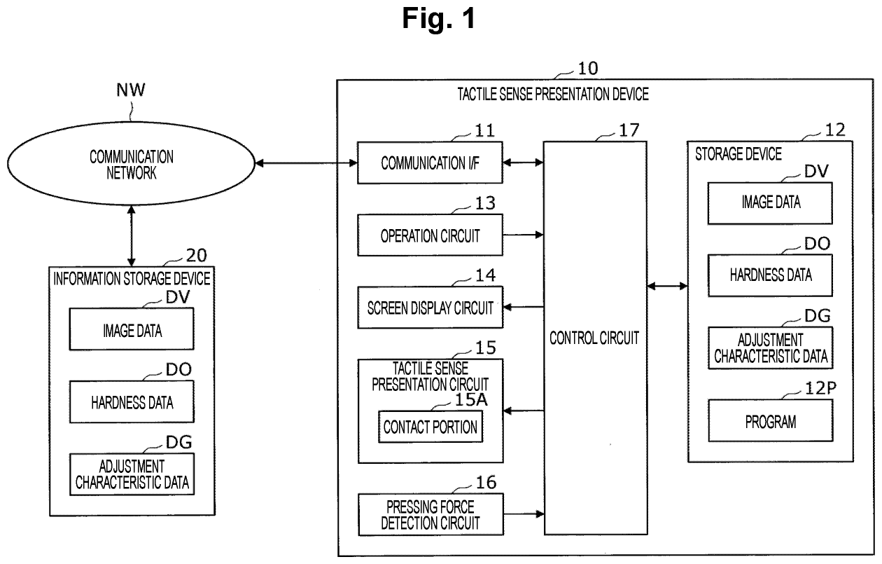

First, a tactile sense presentation device 10 according to the present embodiment will be described with reference to FIG. 1. FIG. 1 is a block diagram illustrating a configuration of the tactile sense presentation device according to the present embodiment. The tactile sense presentation device 10 is a device that presents a cutaneous sensory feedback, that is, a virtual tactile sense, to a person through a tactile sense of force.

In the present embodiment, a case where the tactile sense presentation device 10 virtually presents a tactile sense obtained when a person presses an arbitrary position of an object selected by the person on the basis of hardness at the arbitrary position and a pressing force pressed by the person will be described as an example, but the present embodiment is not limited to the case. For example, in a case where the hardness of the object is constant at any position, a configuration for a person to select the arbitrary position of the object, and a configuration for acquiring the hardness of the selected arbitrary position can be omitted.

As illustrated in FIG. 1, the tactile sense presentation device 10 includes, as a main circuit configuration, a communication interface (hereinafter, referred to as a communication I/F) 11, a storage device 12, an operation circuit 13, a screen display circuit 14, a tactile sense presentation circuit 15, a pressing force detection circuit 16, and a control circuit 17.

### [Communication I/F]

The communication I/F 11 is configured to acquire various processing data used when the tactile sense presentation device 10 presents a tactile sense, such as the hardness of the object, by performing data communication with an information storage device 20 via a communication network NW such as the Internet.

### [Information Storage Device]

The information storage device 20 includes, for example, a server device, and stores image data DV including an image V indicating an appearance and a shape of the object, hardness data DO indicating hardness O at each position of the object, and adjustment characteristic data DG indicating a characteristic of an adjustment coefficient g(F) according to a pressing force of a person, regarding a displacement amount of a contact portion 15A provided in the tactile sense presentation circuit 15. The information storage device 20 is configured to present the object image V of the designated object, the hardness O regarding the designated object and position, and the adjustment coefficient g(F) according to the designated pressing force F, in response to a request from the tactile sense presentation device 10 via the communication network NW.

### [Storage Device]

The storage device 12 includes a storage device such as a hard disk or a semiconductor memory, and is configured to store various processing data and a program 12P used when the tactile sense presentation device 10 presents a tactile sense. Examples of the processing data stored in the storage device 12 include the image data DV, the hardness data DO, and the adjustment characteristic data DG.

The image data DV, the hardness data DO, and the adjustment characteristic data DG are equivalent to DV, DO, and DG stored in the information storage device 20, and it is sufficient that each data is stored in at least one of the information storage device 20 or the storage device 12. The information storage device 20 can be regarded as the storage device 12 externally connected to the tactile sense presentation device 10 via the communication I/F 11 and the communication network NW. By storing the DV, DO, and DG in the information storage device 20, these data can be shared by a plurality of tactile sense presentation devices 10 and can be centrally managed. By storing the DV, DO, and DG in the storage device 12, the tactile sense can be presented from the tactile sense presentation device 10 in a stand-alone manner.

The adjustment characteristic data DG is a characteristic indicating the adjustment coefficient according to the pressing force of the person, regarding the displacement amount of the contact portion 15A provided in the tactile sense presentation circuit 15. Since the DG is expressed by the function g(F) having the pressing force F of the person as a variable, the DG may be stored as a specific function expression or as a table indicating the relationship between the pressing force F and the adjustment coefficient g(F).

The program 12P stored in the storage device 12 cooperates with a CPU of the control circuit 17 to implement various processing units used for tactile sense presentation processing in the control circuit 17. The program 12P is read in advance from an external device or a recording medium (both not illustrated) connected to the tactile sense presentation device 10, and is stored in the storage device 12.

### [Operation Circuit]

The operation circuit 13 includes a pointing device such as a mouse or a touch panel, and is configured to detect an operation of a person and output the operation to the control circuit 17. Examples of the operation detected by the operation circuit 13 include a pointer operation for moving a position of a pointer displayed on the screen of the screen display circuit 14 and a switching operation for switching the operation of the control circuit 17.

### [Screen Display Circuit]

The screen display circuit 14 includes a screen display device such as an LCD, and is configured to display various screens such as an operation menu screen and a setting screen in addition to the image V indicating the appearance and shape of the object in response to an instruction from the control circuit 17.

### [Tactile Sense Presentation Circuit]

The tactile sense presentation circuit 15 includes the contact portion 15A whose pushing position is displaced according to the pressing force of the person, and is configured to present a tactile sense according to the hardness of the object by displacing the pushing position of the contact portion 15A in response to an instruction from the control circuit 17.

### [Pressing Force Detection Circuit]

The pressing force detection circuit 16 includes a sensing device such as a pressure sensor, and is configured to detect the pressing force of the person against the contact portion 15A and output the pressing force to the control circuit 17.

### [Control Circuit]

The control circuit 17 is configured to change the tactile sense to be presented by the tactile sense presentation circuit 15 on the basis of the hardness of the object and the pressing force of the person detected by pressing force detection circuit 16.

Specifically, the control circuit 17 displays the pointer on the screen of the screen display circuit 14 on the basis of the image data DV in the storage device 12, changes the display position of the pointer on the screen to a new position according to the pointer operation of the person detected by the operation circuit 13, and changes the tactile sensation to be presented by the tactile sense presentation circuit 15 on the basis of the hardness at the new position of the object and the pressing force detected by the pressing force detection circuit 16.

At this time, the control circuit 17 may switch an operation of changing the display position of the pointer on the screen to the new position according to the pointer operation detected by the operation circuit 13 and an operation of changing the tactile sense to be presented by the tactile sense presentation circuit 15 on the basis of the hardness at the new position of the object and the pressing force detected by the pressing force detection circuit 16, by the switching operation of the person detected by the operation circuit 13.

The control circuit 17 includes a CPU and peripheral circuits thereof, and reads the program 12P in the storage device 12, executes the program with the CPU, and causes the CPU and the program 12P to cooperate with each other, thereby implementing various processing units used for the tactile sense presentation processing in the control circuit 17.

### Operation of Present Embodiment

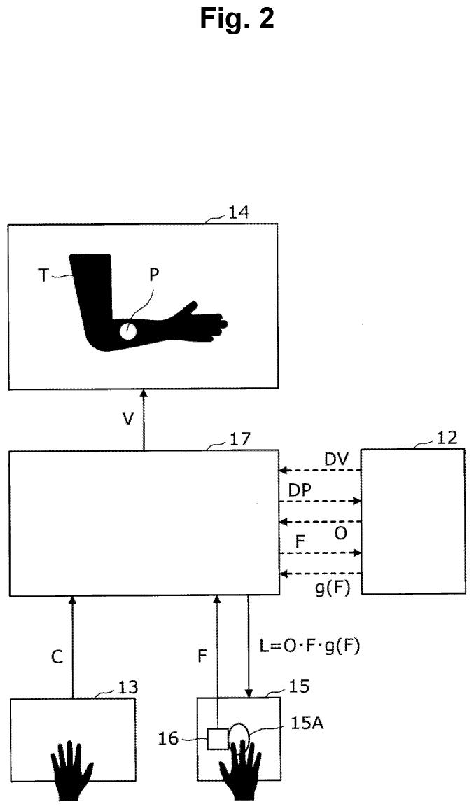

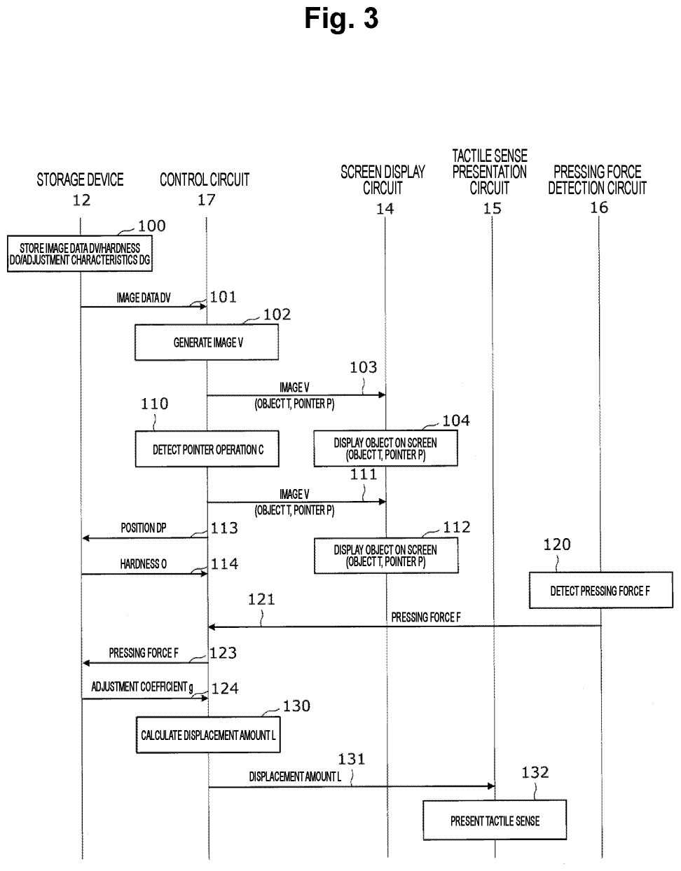

Next, an operation of the tactile sense presentation device 10 according to the present embodiment will be described with reference to FIGS. 2 and 3. FIG. 2 is an explanatory diagram illustrating an operation of the tactile sense presentation device. FIG. 3 is a sequence diagram of a method for controlling the tactile sense presentation device.

Here, a case where the tactile sense presentation device 10 presents the tactile sense to a person on the basis of the image data DV, the hardness data DO, and the adjustment characteristic data DG stored in the storage device 12 will be described as an example. Note that in the case where the DV, DO, and DG stored in the information storage device 20 are used, these data may be acquired from the information storage device 20 via the communication I/F 11 and the communication network NW as described above.

The storage device 12 stores the image data DV, the hardness data DO, and the adjustment characteristic data DG (storage step 100). The control circuit 17 of the tactile sense presentation device 10 acquires the image data DV from the storage device 12, and displays the image V indicating the appearance and shape of an object T on the screen of the screen display circuit 14 on the basis of the image data DV (screen display step 104). As a result, the tactile sense presentation device 10 is a device that tactilely presents the tactile sense of when touching the object T, but can also visually present the object T and is also said to be a visually and tactilely multimodal device.

A captured image of the object T is projected as it is or the object T is displayed as 3D data on the screen V, so that the shape of the object can be visually grasped. In particular, in the case where the object is converted into 3D data, the shape of the object can be confirmed from any viewpoint of 360 degrees, so that a situation of an affected part can be visually grasped in medical care or the like.

Meanwhile, in the case of 3D data, information such as a color of the affected part falls off, and thus it is desirable to present the 3D data together with a video (live image). In this case, examples of the display method include a method of arranging the 3D data and the video in parallel, a method of switching modes, and a method of superimposing the 3D data and the video. Further, it is most desirable to convert the actual object into 3D without impairing actual texture from videos captured from a plurality of viewpoints.

The image V includes a pointer P for selecting the position touched by the person. In a case where a pointer operation C of the person is detected by the operation circuit 13, the control circuit 17 calculates a new position DP of the pointer P displayed on the screen according to the pointer operation C, and displays the image V in which the display position of the pointer is changed to the new position DP (screen display step 112).

The operation circuit 13 can operate the position of the pointer P, and can freely operate the pointer P to right and left, up and down, front and back, or the like. A track pad, a mouse, and the like work together with the screen.

At this time, the operation circuit 13 may switch the operation mode of the control circuit 17 between an operation mode of moving the pointer P and an operation mode of displaying the hardness O at the current position of the pointer P on the screen by the screen display circuit 14. Since the operation circuit 13 has a function to sense movement of a person, it is possible to switch modes by specific interaction.

For example, the mode switching operation can be freely defined to a case where an operation such as a double click or a long press is performed in a case where the pointer P is in a region of the screen where tactile sense information of the object can be presented, or the like. By switching the mode, the person can get the hardness O at an arbitrary position of the object T by moving the pointer P.

In the case where the pointer operation C of the person is detected by the operation circuit 13 (operation step 110), the control circuit 17 acquires the hardness O corresponding to the calculated new position DP from the hardness data DO in the storage device 12. The tactile sense presentation circuit 15 is configured to present the tactile sense corresponding to the hardness O of the object T to the person on the basis of an instruction from the control circuit 17 (tactile sense presentation step 132).

When the pressing force detection circuit 16 detects the pressing force generated when the person touches the tactile sense presentation circuit 15 (pressing force detection step 120), the control circuit 17 acquires the pressing force F from the pressing force detection circuit 16, and changes the tactile sense presented by the tactile sense presentation circuit 15 on the basis of the hardness O and the pressing force F (control step 132). At this time, the control circuit 17 calculates a displacement amount L of the contact portion 15A on the basis of the hardness O and the pressing force F, and displaces the pushing position of the contact portion 15A by the displacement amount L.

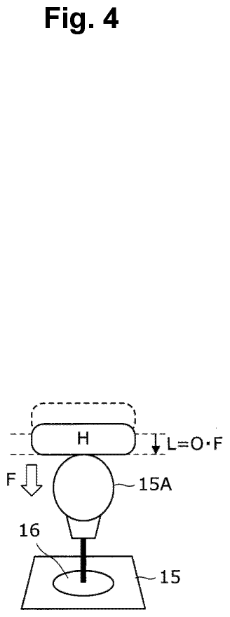

FIG. 4 is an explanatory diagram illustrating the displacement amount of the contact portion. The displacement amount L is obtained by a product O*F of the hardness O and the pressing force F. Therefore, in a case where the person touches the contact portion 15A with a hand H with the pressing force F, the contact portion 15A is pushed in by the displacement amount L=O*F, which is the product of the hardness O and the pressing force F at the new position DP of the object T.

As a result, a repulsive force against the pressing force F generated when the person touches the object changes instead of an absolute tactile sense simply according to the hardness of the object, so that a relative tactile sense corresponding to the pressing force F generated when the person touches the object is presented to the person.

Further, the control circuit 17 may acquire the adjustment coefficient g(F) according to the pressing force F on the basis of the adjustment characteristic data DG in the storage device 12, adjust the displacement amount L obtained from the product of the hardness O and the pressing force F on the basis of the adjustment coefficient g(F), and displace the pushing position of the contact portion 15A by an obtained adjusted displacement amount L′.

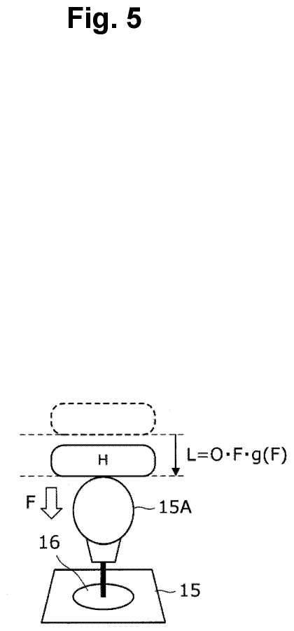

FIG. 5 is an explanatory diagram illustrating an adjusted displacement amount of the contact portion. The adjusted displacement amount L′ is obtained by the product L=O*F*g(F) of the hardness O, the pressing force F, and the adjustment coefficient g(F). Therefore, in the case where the person touches the contact portion 15A with the hand H with the pressing force F, the contact portion 15A is pushed in by the displacement amount L=O*F, which is the product of the hardness O, the pressing force F, and the adjustment coefficient g(F) at the new position DP of the object T.

In general, a tactile sense obtained when a person touches an object having certain hardness O changes depending on the strength of a force generated when the person touches the object, and the person feels a strong tactile sense when the person strongly touches the object and feels a weak tactile sense when the person weakly touches the object. In a case where the tactile sense is changed by the displacement amount L of the contact portion 15A, it is conceivable that the relationship between the pressing force F and the displacement amount L is not a linear relationship with the hardness O as a coefficient but a non-linear relationship. Therefore, as described above, by adjusting the displacement amount L using the adjustment coefficient g(F) having the pressing force F as a variable, it is possible to cope with a case where the pressing force F and the displacement amount L are in a non-linear relationship. Thus, a more realistic tactile sense can be presented.

### Effects of Present Embodiment

As described above, the present embodiment is configured such that the tactile sense presentation device 10 includes: the screen display circuit 14 configured to display the object on the screen; the tactile sense presentation circuit 15 configured to present the tactile sense corresponding to the hardness of the object to a person; and the pressing force detection circuit 16 configured to detect the pressing force generated when the person touches the tactile sense presentation circuit 15, and the control circuit 17 changes the tactile sense to be presented by the tactile sense presentation circuit 15 on the basis of the hardness of the object and the pressing force detected by the pressing force detection circuit 16.

As a result, a repulsive force against the pressing force generated when the person touches the object adaptively changes instead of an absolute tactile sense simply according to the hardness of the object, so that a relative tactile sense according to the pressing force generated when the person touches the object can be presented to the person.

Further, the tactile sense presentation device 10 may further include the operation circuit 13 configured to detect the pointer operation for moving the position of the pointer displayed on the screen, and the control circuit 17 may change the display position of the pointer on the screen to the new position according to the pointer operation detected by the operation circuit 13, and change the tactile sense to be presented by the tactile sense presentation circuit 15 on the basis of the hardness O at the new position of the object and the pressing force F detected by the pressing force detection circuit 16.

Specifically, the storage device 12 may further store the hardness data DO at each position of the object, and the control circuit 17 may acquire the hardness O at the new position of the object from the hardness data DO in the storage device 12 and change the tactile sense to be presented by the tactile sense presentation circuit 15 on the basis of the hardness O and the pressing force F. Thereby, the tactile sense when an arbitrary position of the object is pressed can be presented.

Further, the control circuit 17 may switch the operation of changing the display position of the pointer on the screen to the new position according to the pointer operation detected by the operation circuit 13 and the operation of changing the hardness at the new position of the object, by the switching operation of the person detected by the operation circuit 13. As a result, not only the position change of the pointer but also the hardness at the new position of the object can be displayed on the screen by the operation in the operation circuit 13.

Further, the tactile sense presentation circuit 15 may include the contact portion 15A having the pushing position displaced according to the pressing of the person, and the control circuit 17 may calculate the displacement amount L of the contact portion 15A on the basis of the hardness O and the pressing force F and displace the pushing position of the contact portion 15A by the displacement amount L, thereby presenting the tactile sense corresponding to the hardness O of the object. As a result, a repulsive force against the pressing force F generated when the person touches the object changes instead of an absolute tactile sense simply according to the hardness O of the object, so that a relative tactile sense according to the pressing force F generated when the person touches the object can be presented to the person.

At this time, the storage device 12 may further store the adjustment characteristic data DG indicating the adjustment coefficient g(F) according to the pressing force F of the person, regarding the displacement amount L of the contact portion 15A, and the control circuit 17 may acquire the adjustment coefficient g(F) according to the pressing force F from the storage device 12 on the basis of the adjustment characteristic data DG, adjust the displacement amount L obtained from the product of the hardness O and the pressing force F on the basis of the adjustment coefficient g(F), and displace the pushing position of the contact portion 15A by the obtained adjusted displacement amount L′.

In general, a tactile sense obtained when a person touches an object having certain hardness O changes depending on the strength of a force generated when the person touches the object, and the person feels a strong tactile sense when the person strongly touches the object and feels a weak tactile sense when the person weakly touches the object. In a case where the tactile sense is changed by the displacement amount L of the contact portion 15A, it is conceivable that the relationship between the pressing force F and the displacement amount L is not a linear relationship with the hardness O as a coefficient but a non-linear relationship. Therefore, as described above, by adjusting the displacement amount L using the adjustment coefficient g(F) having the pressing force F as a variable, it is possible to cope with a case where the pressing force F and the displacement amount L are in a non-linear relationship. Thus, a more realistic tactile sense can be presented.

### Extension of Embodiments

Although the present invention has been described with reference to an embodiment, the present invention is not limited to the above embodiment. Various changes that can be understood by those skilled in the art can be made to the configuration and detail of the present invention, within the scope of the present invention.

### REFERENCE SIGNS LIST

10 Tactile sense presentation device
11 Communication I/F
12 Storage device
12P Program
13 Operation circuit
14 Screen display circuit
15 Tactile sense presentation circuit
15A Contact portion
16 Pressing force detection circuit
17 Control circuit
20 Information storage device
NW Communication network
DV Image data
DO Hardness data
DG Adjustment characteristic data
O Hardness
F Pressing force
g(F) Adjustment coefficient
L Displacement amount

1-8. (canceled)

9. A tactile sense presentation device, comprising:
a storage device configured to store image data indicating an object;
a screen display circuit configured to display the object on a screen on a basis of the image data;
a tactile sense presentation circuit configured to present a tactile sense corresponding to hardness of the object to a person;
a pressing force detection circuit configured to detect a pressing force generated when a person touches the tactile sense presentation circuit; and
a control circuit configured to change the tactile sense to be presented by the tactile sense presentation circuit on a basis of the hardness of the object and the pressing force detected by the pressing force detection circuit.

10. The tactile sense presentation device according to claim 9, further comprising:
an operation circuit configured to detect a pointer operation for moving a position of a pointer displayed on the screen, wherein
the control circuit changes a display position of the pointer on the screen to a new position according to the pointer operation detected by the operation circuit, and changes the tactile sense to be presented by the tactile sense presentation circuit on the basis of the hardness at the new position of the object and the pressing force detected by the pressing force detection circuit.

11. The tactile sense presentation device according to claim 10, wherein
the storage device further stores the hardness at each position of the object, and
the control circuit acquires the hardness at the new position of the object from the storage device, and changes the tactile sense to be presented by the tactile sense presentation circuit on the basis of the hardness and the pressing force.

12. The tactile sense presentation device according to claim 10, wherein the control circuit switches an operation of changing the display position of the pointer on the screen to the new position according to the pointer operation detected by the operation circuit and an operation of displaying the hardness at the new position of the object on the screen by a switching operation detected by the operation circuit.

13. The tactile sense presentation device according to claim 9, wherein
the tactile sense presentation circuit includes a contact portion having a pushing position displaced according to pressing by a person, and
the control circuit calculates a displacement amount of the contact portion on the basis of the hardness and the pressing force, and presents the tactile sense corresponding to the hardness of the object by displacing the pushing position of the contact portion by the displacement amount.

14. A method comprising:
storing, by a storage device, image data indicating an object;
displaying, by a screen display circuit, the object on a screen on a basis of the image data;
presenting, by a tactile sense presentation circuit, a tactile sense corresponding to hardness of the object to a person;
detecting, by a pressing force detection circuit, a pressing force generated when a person touches the tactile sense presentation circuit; and
changing, by a control circuit, the tactile sense to be presented by the tactile sense presentation circuit on a basis of the hardness of the object and the pressing force detected by the pressing force detection circuit.

15. The method according to claim 14, further comprising:
detecting, by an operation circuit, a pointer operation for moving a position of a pointer displayed on the screen;
changing, by the control circuit, a display position of the pointer on the screen to a new position according to the pointer operation detected by the operation circuit; and
changing, by the control circuit, the tactile sense to be presented by the tactile sense presentation circuit on the basis of the hardness at the new position of the object and the pressing force detected by the pressing force detection circuit.

16. The method according to claim 14, further comprising:
displacing a pushing position of a contact portion included in the tactile sense presentation circuit according to pressing by a person;
a step of calculating, by the control circuit, a displacement amount of the contact portion on the basis of the hardness and the pressing force; and
a step of presenting, by the control circuit, the tactile sense corresponding to the hardness of the object by displacing the pushing position of the contact portion by the displacement amount.

17. A tactile sense presentation system, comprising:
a tactile sense presentation device configured to present a tactile sense corresponding to a hardness of an object to a person and to detect a pressing force generated when the person touches the tactile sense presentation device;
a control circuit configured to change the tactile sense to be presented by the tactile sense presentation device on the basis of the hardness of the object and the pressing force detected by the tactile sense presentation device;
a screen display circuit configured to display the object on a screen, wherein the tactile sense corresponds to a visual representation of the object's hardness as displayed on the screen;
an operation circuit configured to detect a pointer operation for moving a position of a pointer displayed on the screen; and
a feedback mechanism configured to provide a variable resistance to the person's touch, wherein the variable resistance is adjusted by the control circuit in response to the detected pressing force and the hardness data of the object at the position where the touch occurs.

18. The system of claim 17, wherein the tactile sense presentation device includes a contact portion having a pushing position configured to be displaced according to the pressing of the person.

19. The system of claim 18, wherein the control circuit is configured to calculate a displacement amount of the contact portion on the basis of the hardness and the pressing force and displace the pushing position of the contact portion by the displacement amount.

20. The system of claim 19, wherein the control circuit is further configured to adjust the displacement amount using an adjustment coefficient having the pressing force as a variable.

21. The system of claim 17, further comprising a storage device configured to store hardness data at each position of the object, wherein the control circuit is configured to acquire the hardness at a new position of the object from the hardness data in the storage device.
